(19) United States
(12) Patent Application Publication
(10) Pub. No.: US 2011/0075994 A1
(43) Pub. Date: Mar. 31, 2011

(54) System and Method for Video Storage and Retrieval

(76) Inventors: Hsiao-Shu Hsiung, San Jose, CA (US); Bin Qian, Santa Clara, CA (US); John Hsueh, Fremont, CA (US)

(21) Appl. No.: 12/568,458

(22) Filed: Sep. 28, 2009

(51) Int. Cl. H04N 5/91; H04N 9/64; H04N 5/50; H04N 5/917; H04N 5/783; H04N 7/26

(52) U.S. Cl. 386/330; 348/714; 348/731; 348/E09.037; 348/E05.097; 386/E05.001; 386/343

(57) ABSTRACT

A method and system for providing functionality similar to that found in a DVR but mostly or completely contained within a television set is disclosed. A memory stores packets representing a portion of one or more programs in the broadcast stream and allows a viewer to replay that portion of the program using some of the functions available on a DVR, such as pause, rewind, and fast forward. The packet stream is divided into groups of equal length and fixed time duration, for example one second, and stored in sequential order in the memory. This allows for the storage and retrieval of content without the need for an index file, without adding a timestamp to the program data packets, and without separating the audio portion from the video portion of the program and then having to synchronize and recombine them.

### FIELD OF THE INVENTION

The present invention relates generally to video storage and retrieval, such as for the time shifting of television signals. More specifically, the present invention relates to implementing functions of a digital video recorder in a simple and efficient manner.

### BACKGROUND OF THE INVENTION

The digital video recorder (DVR) has all but replaced the video cassette recorder (VCR) for the recording and playback of stored television programs. While the VCR used videotape to provide viewers with the ability to time shift programs (i.e., to record and playback at a different time than the program was aired), as well as to fast forward, for example through commercials, or playback favorite scenes, it still had significant limitations. For example, a VCR cannot record and playback at the same time, thus preventing a viewer from pausing a program momentarily to perform some task or from replaying a portion of the program while the recording is in progress, for example to review a key scene or hear a piece of missed dialogue, and then resuming normal viewing. Rather, the viewer must either stop recording or wait until the entire program is recorded and then rewind the videotape to the desired portion.

The introduction of the DVR, which records video in a digital format to a hard disk drive or other memory device, solved a number of these problems. A typical DVR lets the user pause the program or go to an earlier portion of the program and view it while the recording of the program is in progress, and then continue normal viewing from that point (known as “chasing playback” as it is time-delayed from the portion of the program currently being aired), and/or fast forward to the current portion of the program, for example during a commercial break. As with the VCR, the DVR typically allows for indefinite storage of a program for later viewing.

However, typical DVRs are somewhat complex. They are typically contained in “set top boxes,” separate components such as those provided by TiVo or DISH Network which are intended to sit on top of or near a connected television and often also provide program guides that may be displayed on the television. Many such devices have dual tuners within the same receiver that operate independently of one another. This allows a viewer to record a live program while watching another live program simultaneously, or to record two programs at the same time while watching a previously recorded one. Some dual-tuner DVRs also have the ability to operate two separate television sets at the same time, and some DVRs have more than two tuners. (A television may similarly have dual tuners to allow for “picture-in-picture” capability, i.e., watching one channel while another channel appears as a smaller inset on the screen.)

One key issue in saving program content is how to retrieve content from a particular time for later viewing. While videotape requires scrolling through the recorded data to the desired point by winding the tape, DVRs allow faster direct access to particular parts of the memory used to store program content. However, it can still be difficult to locate the content from a particular time if a large amount of data is stored. While a typical broadcast transport stream, such as an MPEG-2 or H.264 stream, contains a presentation time stamp (PTS), the PTS is not present in every frame or packet, and thus there is not enough information to be able to access every portion of program data that may be selected.

To address this problem, conventional DVRs all make use of a time stamp and index file to allow content to be located quickly. When a program stream is recorded, a timestamp is inserted into the header of each data packet. When the DVR viewer seeks content using timing information, such as during fast forward or rewind, the timestamp information can be searched, and data extracted from the memory when the desired time is found.

Merely using a timestamp does not fully solve the problem, as it can take a long time to search for a timestamp if the program content file is large. Thus, an index file is created which maps from each timestamp to a respective address in the memory where the content is stored. When the viewer seeks content, the DVR can get the location of the data quickly by searching only the mapping table in the index file, rather than having to search the program data itself.

Even this solution has drawbacks, however. The insertion of the timestamp into the data packets generally requires dedicated hardware support to achieve real-time processing, thus again increasing the complexity and cost of the device. In the H.264 format, it can be difficult to locate the appropriate frame in which to insert the timestamp even with such hardware support. Further, if the mapping table is wrong, or if the index is corrupted for any reason, the system will be unable to retrieve the correct program content from the storage device, potentially rendering the entire program unviewable.

Another cost consideration is that typical DVRs contain two kinds of memory, a hard disk for long term storage of programs, and a volatile short term memory that, similarly to RAM in a computer, generally loses its contents when the device is turned off and is also cleared when the viewer changes the channel. The need for these two different memories, and the means to read from and write to both, again increases the cost and complexity of the device.

In addition to the tuners, typical DVRs also have significant other signal processing circuitry. For example, various TiVo patents describe converting incoming signals to an internal MPEG format (even if the signals are received in an MPEG format), separating the audio and video components of the signals for storage, and then recombining them for playback (see, e.g., U.S. Pat. No. 6,233,389), as well as the use of multiple caches for storing these components and stream clocks and synchronization means for insuring that the components are played back simultaneously. (See, e.g., U.S. Pat. Nos. 6,327,418 and 6,792,195.) The tuners and other processing circuitry needed for this functionality contribute to the size and expense of typical DVRs.

It is believed that there have been some efforts to locate a DVR within a television set, although this has not been widespread, apparently due to the increased size and cost of the television needed to accommodate the additional circuitry needed. However, such efforts indicate the desirability of including at least some DVR functionality within a television set without the need for an external box or other piece of equipment, or with minimal external hardware. It would be particularly advantageous to do so with minimal expense and circuitry requirements.

### SUMMARY OF THE INVENTION

The present invention is designed to provide certain functionality similar to that found in a DVR such as those provided by Tivo or Dish Network, but is intended to be mostly or completely contained within a television set. In some embodiments, a device allows for storage of a portion of the program on the channel that is being displayed on the television set (and perhaps other channels as well as described herein) and allows a viewer to replay that portion of the program using some of the functions available on a DVR, such as pause, rewind, and fast forward.

The present invention allows for the location of content without the need for an index file, without adding a timestamp to the program data packets, and without separating the audio portion from the video portion of the program and then having to synchronize and recombine them. Rather than saving the program content into a single big file or two big files, one for audio and one for video, the device saves the program content into files of equal length and a fixed time duration, for example one second, and stores them in sequential order.

In one embodiment, the present invention provides a method for storing a video signal comprising receiving one or more streams of broadcast video signals in a digital format, each stream containing a plurality of program signals and each program signal comprised of a series of frames, selecting a received stream, dividing the selected stream into groups of frames such that each group is of approximately equal broadcast time duration, without otherwise altering the format of the frames, and storing the groups sequentially in a memory in the same order and digital format in which the stream was received.

In another embodiment, the invention provides a method for storing and retrieving a video signal, comprising receiving one or more streams of broadcast video signals in a digital format, each stream containing a plurality of program signals and each program signal comprised of a series of frames, selecting a received stream, dividing the selected stream into groups of frames such that each group is of approximately equal broadcast time duration, without otherwise altering the format of the frames, storing the groups sequentially in a memory in the same order and digital format in which the stream was received, selecting a plurality of the stored groups to retrieve, retrieving the selected stored groups, and reproducing the broadcast video signal represented by the selected stored groups.

In still another embodiment, the invention provides a system for storing and retrieving a video signal contained in a stream of broadcast video signals in a digital format, the stream containing a plurality of program signals and each program signal comprised of a series of frames, the system comprising a tuner for selecting a program from the plurality of programs contained in the stream, a buffer for dividing the frames of the selected program into groups of frames such that each group is of approximately equal broadcast time duration, without otherwise altering the format of the frames, a memory input/output means for reading the groups of frames into and out of a memory and causing the memory to store the groups of frames sequentially in the same order and digital format in which the stream was received, a control means for designating to the input/output means which groups of frames are to be read out of the memory, and an output means for providing the groups of frames to a video decoder for reproduction of the video signal represented by the selected groups of frames.

### BRIEF DESCRIPTION OF THE DRAWINGS

FIG. 1 is a block diagram of a high level view of a video recording device according to one embodiment of the present invention.

FIG. 2 is a timing diagram showing the operation of a video recording device in one embodiment of the present invention.

FIG. 3 is a more detailed block diagram of a video recording device according to one embodiment of the present invention.

FIG. 4 is a flowchart of a method according to one embodiment of the present invention.

### DETAILED DESCRIPTION OF THE INVENTION

The present invention stores digital television signals and allows for their playback with certain functionality of a conventional DVR. It is possible for the invention to be implemented as a small and inexpensive device that may be contained primarily, if not completely, within a television set so that no external device or only a small and inexpensive external device is needed.

Digital television broadcasts are generally sent in a standard format, typically an MPEG-2 “transport stream format,” received either over the air or via cable. (The H.264 format, which is part 10 of the MPEG-4 standard, is also becoming more common.) Television cameras used in broadcasting generate 25 (Europe) to 29.97 (North America) frames per second. Under MPEG-2, the raw video frames are compressed into three kinds of frames: intra-coded frames (I-frames), predictive-coded frames (P-frames, or delta-frames), and bidirectionally-predictive-coded frames (B-frames).

An I-frame is a compressed version of a single uncompressed (raw) frame, in effect a fully-specified picture, like a conventional static image file. Unlike P-frames and B-frames, I-frames do not depend on data in the preceding or the following frames. A P-frame holds only the changes in the image from the previous frame. For example, in a scene where an object moves across a stationary background, only the object's movements need to be encoded. The encoder does not need to store the unchanging background pixels in the P-frame, and thus results in greater compression. A B-frame saves even more space by using differences between the current frame and both the preceding and following frames to specify its content.

Typically, every 15th frame or so is made into an I-frame. P-frames and B-frames might follow an I-frame in a sequence such as:

IBBPBBPBBPBB(I)

to form what is called a Group Of Pictures (GOP).

The stream of frames forms an Elementary Stream (ES); the separately recorded audio forms another elementary stream. The elementary streams are multiplexed together and packetized by encapsulating sequential data bytes from the elementary stream inside packet headers to form a Packetized Elementary Stream (PES). A typical method of transmitting elementary stream data from a video or audio encoder is to first create the PES packets from the elementary stream data and then to encapsulate these PES packets inside transport stream (TS) packets or a program stream. The TS packets can then be multiplexed and transmitted using standard broadcasting techniques.

An MPEG-2 formatted stream with a 6 MHz spectrum band can carry up to 4 multiplexed standard definition program signals, i.e., four channels, or 1 high definition (HD) signal and 1 standard signal by multiplexing the signals. A single MPEG-2 stream may thus contain from 100 to 120 frames per second (25 to 29.97 frames per program per second, up to 4 standard definition programs per stream).

Cable or satellite systems use multiple bands to carry the numerous channels available. Each program within a band has a program identification code (PID). To watch or record a single program, a tuner selects a single band from those received, and the signal stream is demultiplexed to obtain the selected program based on the PID. As above, there may be multiple tuners in a single device. The audio and video signals are demultiplexed and depacketized to obtain data that may be displayed on a screen or heard through a speaker system.

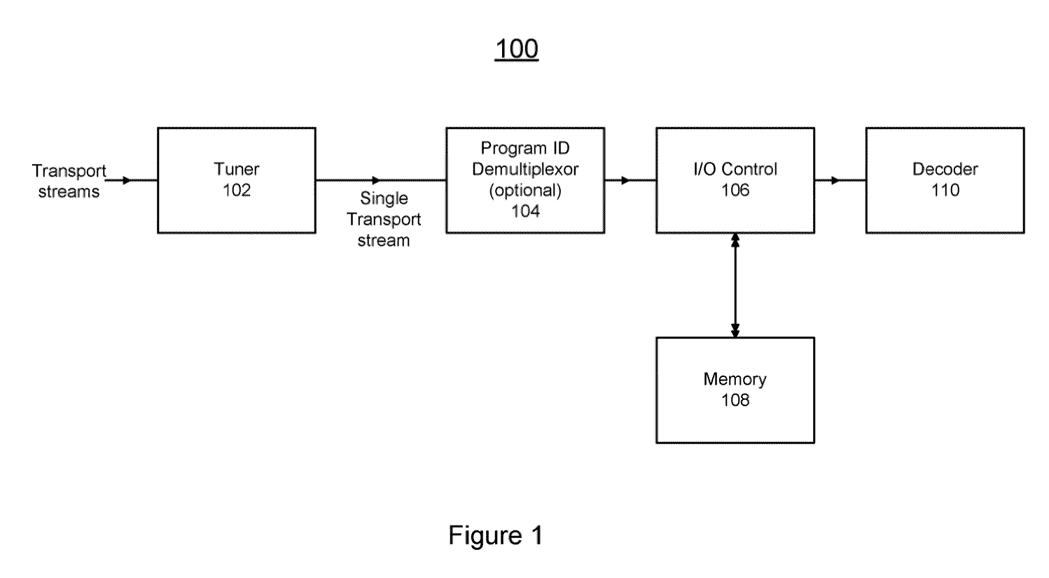

Referring to FIG. 1, a block diagram of a high level view of one embodiment of the present invention is shown. A television 100 contains a tuner 102 that receives, for example, MPEG-2 or other transport streams and selects one of the streams for recording. (MPEG-2 streams are used as an example herein; however, it will be appreciated that the transport stream may be an H.264 stream or other format.) If desired, an optional demultiplexor 104 selects a single program from the selected MPEG-2 stream by using the PID. An I/O (input/output) controller 106 takes the packets in the selected stream, or the selected program portion of the stream, and stores them in a memory 108. When the viewer desires to view the stored program, controller 106 retrieves the selected packets, as discussed below, and sends them to a decoder 110 where they are decoded for display.

The system may by default store the program stream being watched. Alternatively, controls may allow the viewer to store a different program from the same MPEG-2 stream, or to store the entire stream. Since the stream contains more than one program, in this instance a shorter length of the stream will be stored than if only a single program is stored.

In contrast to prior DVR devices, in the present invention the incoming MPEG-2 stream is not decoded or otherwise processed, other than the optional demultiplexing to locate a single program within the stream. Rather, the stream is merely divided into small groups of packets of approximately equal program length; in one embodiment, the desired length of each group is approximately one second long. The groups of packets are then stored sequentially as they have been received directly over the air or cable; there is no other alteration of the signal before it is stored. The signal is not decoded or converted into any other format for storage, and the audio and video components of the signal are not separated.

When data is retrieved from the memory, if the entire MPEG-2 stream has been saved, the signal is demultiplexed to select a desired program, while if the signal is already that of a single program this is no longer necessary. In either case, the packets are fed to other circuitry in television 100 in which they will be processed by a decoder 110 just as if they had just been received over the air or from cable, and the decoder 110 decodes the data for viewing as if it were a live signal stream.

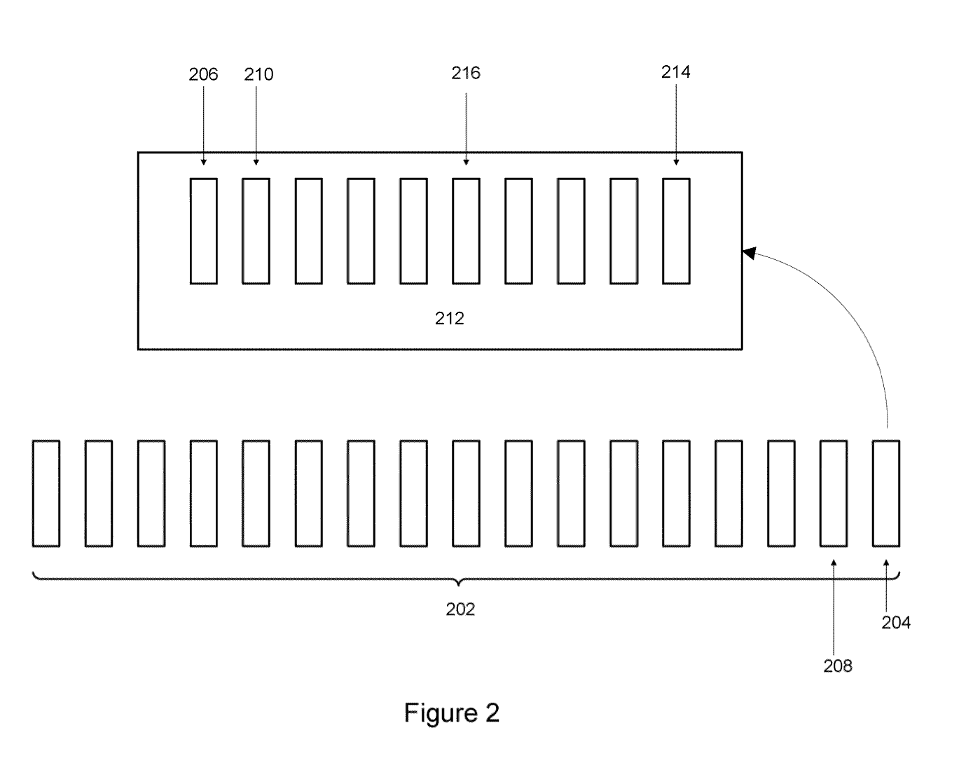

FIG. 2 is a timing diagram showing the operation of a video recording device in one embodiment of the present invention. A stream of packets 202 is received; as above, the stream 202 may be all of the packets in a selected MPEG-2 stream or may be only the packets associated with a specific PID within the MPEG-2 stream. The stream is divided into groups of packets representing approximately equal lengths of time.

As each group of packets is received, it is sent to the memory 212 and stored as a single file, as above with no processing. The resulting files are stored in sequential order. When the device is first activated, the memory is empty, and the first group of packets received 204 is stored in the first memory location 206, the next received group of packets 208 in the next memory location 210, etc., until the memory is full and the latest group of packets received is stored in the last memory location 214.

When the end of the memory is reached, the device returns to the beginning of the memory and continues to store groups of packets from there. The next received group of packets is then stored in the first memory location 206, and the first group of packets 204, which is now the oldest group of packets in the memory, is overwritten and thus discarded. This may continue as long as the device is on and recording, so that if the device is on for an extended period a memory location may be overwritten multiple times. Thus, in a similar fashion to one function of conventional DVRs, the memory always contains the most recently received groups of packets that will fit within the memory in sequential order (other than the “wraparound” from one end of the memory to the other).

Suppose a program or stream is recorded beginning at 10:00:00. The first group of packets containing data from 10:00:00 to 10:00:01 will be stored in memory location 206, the next group of packets containing data from 10:00:01 to 10:00:02 will be stored in memory location 210, etc. If the memory is capable of storing data for an hour, for example, the packets containing data from 10:59:59 to 11:00:00 will be stored in the last memory location 214, and packets containing data from 11:00:00 to 11:00:01 will then be stored in the first memory location 206, overwriting the previously stored data from 10:00:00 to 10:00:01.

In contrast to conventional DVRs, there is no index. There is a simple pointer 216 that initially points to the most recently received group of packets in the last memory position 214. In order to access data at different times, the pointer 216 is moved by simply counting files, i.e., blocks of packets, until the desired time is reached. If the desired location is known at which playback is desired, i.e., the desired “start time,” the appropriate number of seconds may be counted and the pointer moved to that location so that playback may start immediately, without viewing the intervening memory locations.

Thus, again, if the memory stores a program that started at 10:00:00, and it is now 11:00:00, and the pointer points to the most recent memory location 214, to access the content from 10:00:00 it is necessary to count back 3600 locations in memory, i.e., 60 minutes times 60 seconds, since each location stores one second of packets. To access content at 10:30:00, the device counts back 1800 locations, for content at 10:50:00 it counts 600 locations, etc.

In some embodiments, the pointer and counter provide functionality similar to that of the short term memory of a DVR, or that of a VCR, namely fast forward and rewind. Typical DVRs accomplish this by only reading the I-frames in the MPEG-2 stream, and not the P-frames or B-frames. This allows for very fast scanning through recorded data, but because not all of the frames are displayed, the viewer will not see a smooth picture but rather a jerky and discontinuous one. Also, this again requires both time stamps and hardware support.

By contrast, in the present invention every memory location is output to the decoder. Since data is stored at a rate of one memory location per second, this is accomplished by moving the pointer and reading the memory locations at a rate greater than one per second. As will be discussed below, while not all frames may be displayed, so that the program will appear to run at a rate faster than the rate at which the frames were broadcast, more frames will be displayed than just the I-frames, resulting in a smoother picture.

To rewind, the counter moves the pointer “backwards,” i.e., so that it points to locations moving from the most recent location in memory 214 toward the earliest location in memory 206. As the pointer reaches each location, the memory at that location may start to be read, resulting in an image on the screen, as is common in DVRs. To scan at a rate faster than normal, the pointer is moved to more than one memory location per second, and each location is read as the pointer reaches it, thus creating the illusion that the program is playing backwards at greater than normal speed, as is also common in DVRs and some VCRs, but without the discontinuity described above that results from reading only I-frames.

Similarly, where the pointer has been moved and does not point to the most recent memory location 214, but to some earlier memory location, a “fast forward” function may move the pointer by more than one memory location per second, resulting in the appearance of the program playing at greater than real-time speed. Again, this fast forward functionality is standard in DVRs and VCRs, but again the present invention will result in a smoother picture than conventional DVRs.

As above, the memory is of a finite size, and when the memory is full the device continues to store groups of packets by overwriting the memory locations containing the oldest data. There will typically be a limit on the range of the counter, as counting over a range greater than the memory storage will result in reading the wrong program data. Thus, if the memory can store one hour of program, the counter should have a range of 3600 units, representing the 3600 seconds, and thus memory locations, available in the memory. Either the pointer or counter should be programmed so that if the newest group of packets is somewhere in the middle of the memory and the counter moves the pointer backwards sufficiently far, the device will “wrap around” and move the counter from the lowest memory location 206 to the highest memory location 214 at the appropriate place.

The counter requires only simple mathematical calculations, and thus any desired time may be quickly calculated, and the pointer adjusted to indicate the portion of the memory that is desired to be read. Once a desired location is reached, a “play” command may be entered, and the device then reads the memory locations sequentially so that the blocks of packets are obtained in the same order as they were originally received. Again, if the newest data is not in the last memory location 214, the system will “wrap around” and continue to read data from the first memory location 206 until and unless it catches up with data being currently received.

As is typical in DVRs, the system may have a “pause” command which pauses playback and keeps the pointer where it is until either another command is entered or the pointer is at the oldest data location, or a “live” command upon which playback of recorded data ceases, the system displays current data and the pointer returns to the newest data location.

A “jump” function may also be implemented in which the pointer moves a predetermined number of memory locations, and thus a predetermined time, backward or forward with each push of a key, and may also allow the viewer to make multiple sequential jumps by holding the key down. Thus, for example, the device may be instructed to jump 10 memory locations, i.e., 10 seconds, without displaying all of the intervening data, allowing a viewer to review a missed line of dialog, or to quickly scroll through commercials. Again, all that is necessary is that the counter be programmed to increment by the predetermined number of locations, here 10, rather than one location at a time.

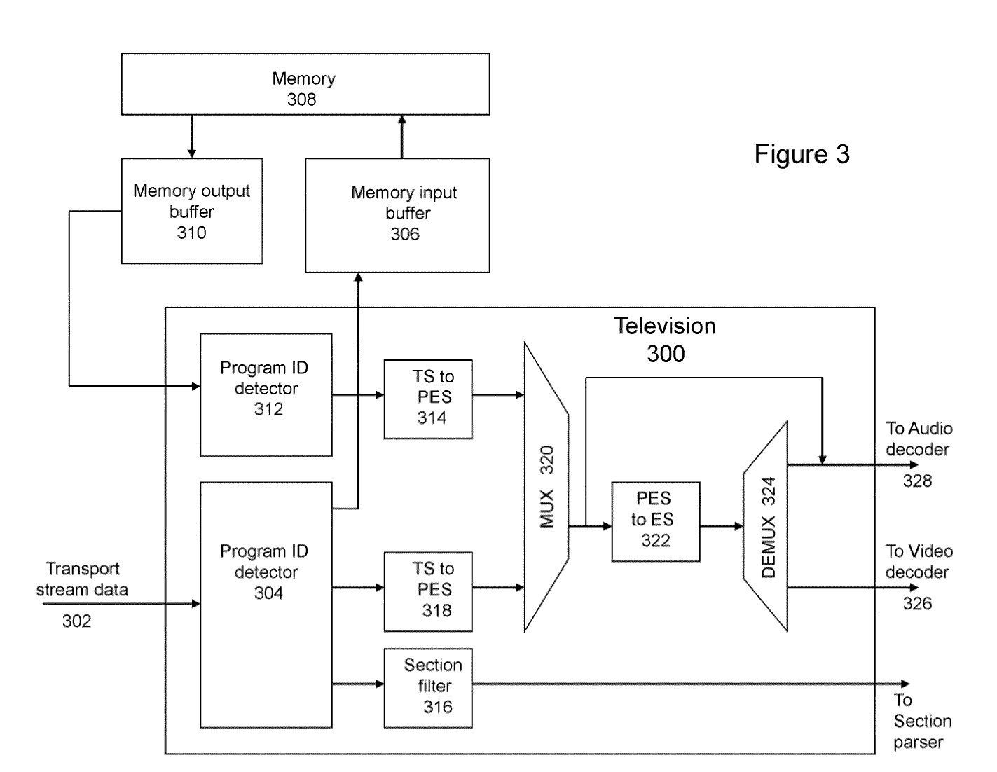

A more detailed block diagram of an embodiment of a device including the present invention is shown in FIG. 3. Television 300 receives a transport stream TS at input 302. The transport stream is fed to a PID detector 304 to select one of the programs contained in the stream. The packets representing the audio and video portion of the selected program are sent through a buffer 306 to be stored in a memory 308 as described above. When it is desired to play back this recorded data, the requested data is read through a buffer 310 back into television 300, and fed to a TS to PES converter 314, that converts the selected program portion of the transport stream to a Packetized Elementary Stream (PES). If a program was not previously selected by the PID detector 304 but the entire transport stream was stored, the PID detection may be done here as well by PID detector 312 to select a desired program from the transport stream.

The live signal is fed to a section filter 314, which interprets the section data contained in the program portion of the transport stream that identifies the selected program, and sends that data to a section parser for display on the screen at the viewer's discretion. The live signal is also fed to another TS to PES converter 318, that similarly converts the selected program portion of the transport stream to a Packetized Elementary Stream (PES).

A multiplexor 320 selects which program is displayed. If the viewer selects a current broadcast, multiplexor 320 will select the “live” PES from convertor 318. If the viewer has used the DVR capability to view recorded data, multiplexor 320 will select the recorded data from converter 314.

As above, the data is stored in memory 308 in the form in which it is received, except for the possible detection of the PID. Thus, once the desired signal is selected by multiplexor 320, further processing of the signal is identical whether the signal is being currently broadcast and received, or has been previously received and stored in memory 308.

The PES signal selected by multiplexor 320 is fed to a PES to ES convertor 322, and the resulting Elementary Stream is then fed to a demultiplexor 324 to obtain the video portion of the ES at output 326, from which it goes to a video decoder for display. The demultiplexor 324 also produces an audio portion of the program which is output at 328. The PES signal from the multiplexor 320 is also fed to the output 328 since there may be other non-audio information contained in the PES signal, such as closed-captioning, similarly to how the section data is contained in the transport stream as described above.

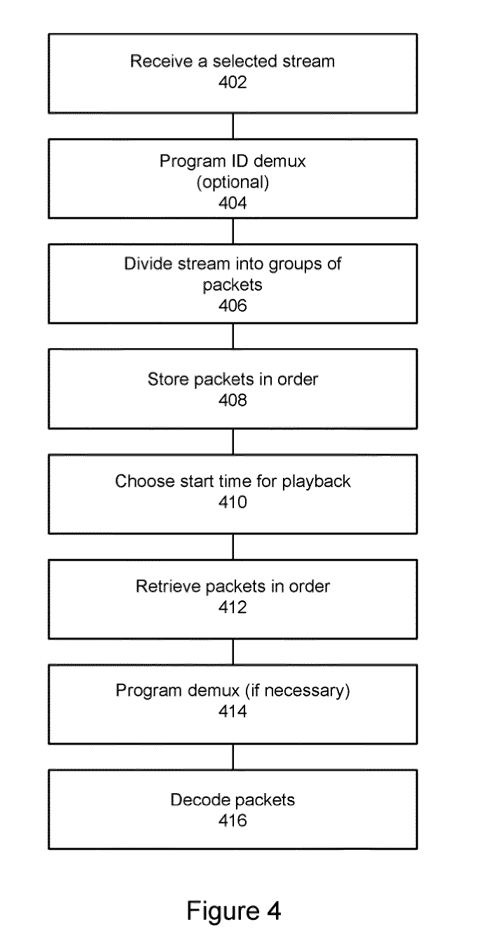

FIG. 4 is a flowchart of a method according to one embodiment of the present invention. A stream is received at step 402, selected from multiple transport streams if necessary. At optional step 404, the program ID is used to demultiplex the stream and locate a specific program. The resulting stream, whether the entire transport stream or a single program, is then divided into groups of packets at step 406, with each group containing packets of approximately equal stream or program time duration. At step 408, the groups of packets are then stored in a memory in the order received.

To playback a recorded stream or program, the point at which playback is to commence is first chosen at step 410. As described elsewhere herein, this may, for example, be done with a pointer, and may include forms of playback that are faster than normal and/or are in reverse. The packets are then retrieved in the order in which they were received (or reverse order for reverse functions) at step 412. If a specific program was not selected previously, i.e., if step 404 was omitted, the stream is demultiplexed by use of the program ID at step 414. Finally, the packets are decoded as if they have been received in a live transport stream at step 416.

In some embodiments, only a single tuner is present in the television. In this case it is possible for one program (or channel) to be viewed on the television while another program from another channel within the same MPEG-2 stream is stored in the memory. However, a single tuner means that there is no ability to view and record shows from channels in different bands simultaneously. If desired, multiple tuners may be used so that channels from different bands may be recorded and viewed simultaneously, but this obviously increases the complexity and cost of the device.

As described above, it is contemplated that embodiments of the present invention that utilize a single memory to store all of the incoming MPEG-2 signal stream or the specific desired program portion will be the simplest and cheapest to implement. However, it will be obvious to one of skill in the art that non-volatile or multiple memories may be used for increased flexibility, in a similar fashion to conventional DVRs, at an increased cost and complexity.

The memory may be of any type, such as flash, hard disk, etc., and of any desired size. One of skill in the art will appreciate that each type of memory has advantages and disadvantages that should be taken into account in deciding which type to use. Hard disks generally have an expected life of several years, while the reliability of flash memory is measured in how many read/write cycles may be performed before cells fail and can no longer be used.

Also, while it is expected that most of the circuitry described herein will be located within a television, the issue of the memory's expected lifetime and reliability should also be considered in determining whether to also locate the memory within the television. If the expected lifetime of the television exceeds the expected lifetime of the memory, there is a risk that in the event of memory failure the television will have to be repaired, generally at a location other than the viewer's premises, resulting in a gap in the viewer's ability to use the television.

To avoid this problem, in some embodiments such as that in FIG. 3, the memory is external to the television and an appropriate input/output interface is built into the television circuitry. For example, the memory may be an external hard drive, and the input/output interface may be a USB interface, which is well known in the art. In such an embodiment, failure of the hard disk will result in loss of any data stored on the hard disk, but will not cause a gap in the availability of the television, and attaching a new hard disk to the USB interface will restore the DVR functionality.

The size of the memory obviously dictates the length of the program that may be stored. A typical MPEG-2 stream contains approximately 2.5 megabytes of data per second of broadcast time. Thus, a single standard definition program within the stream would contain about one-quarter of this amount of data. Again, increased memory results in increased cost, and it is thus contemplated that in some embodiments the size of the memory will be limited to some amount believed to be sufficient for most users, just as the “current program” memory in present set top boxes is typically limited.

Since there is no time stamp data and no index or synchronization, the speed of either fast forward or rewind in the device will generally be limited by the time it takes to decode the segments, which is generally a function of processor speed, although it may also be limited by the time needed to locate and read the segments, which is limited by both processor speed and memory access speed.

As above, other DVR devices such as those from Tivo or Dish Network can typically display programs in fast forward or reverse mode at 32 times normal speed or more by only reading I-frames. In contrast, the fast forward and reverse modes of the present invention are currently expected to be most useful at four times normal speed. This is because the normal rate for “real time” display is the 30 frames per second that a television can display, while many decoders are limited to 120 frames per second. Thus, while as above it is contemplated that in the present invention all of the memory locations will be read, the decoder will be unable to process them at more than four times normal speed. Further, the television will be unable to display them all and will thus be limited to displaying every fourth frame. While faster speeds could be obtained by skipping over frames, this would require more complicated counters and would result in less smooth displays, as in conventional DVRs at high speeds.

While it is contemplated that decoders may become faster, there are other bandwidth limitations as well, such as the memory input/output path. Using a memory input/output bandwidth of 32 bits (such as 2 DDR2 memory paths of 16 bits each), it is possible to match the decoder described above and achieve four times normal speed. Obtaining faster speeds requires not only a faster decoder, but that all the memory paths be faster, and as will be known to one of skill in the art other issues arise so that merely switching to DDR3, which has 32 bit memory paths, by itself will not result in doubling the speed of the I/O.

The present invention is contemplated to work only with a digital signal stream, whether received over the air or via cable, and not with analog signals which require substantially different circuitry.

It will thus be seen that in the present invention there is no need to insert timestamps into the data packets, and no need to construct an index file. The lack of necessity of special hardware for these purposes means the system may be simpler and of lower cost.

The present invention is also more reliable than more complex systems, with greater fault tolerance. When a storage device is damaged, the file system may still be used around the damaged area. Corruption of the data even after recording may not render the entire program unviewable, as the damaged portions may simply be skipped during playback and interruptions may be as short as one second or less.

Various design choices will be apparent to one of skill in the art. The length of the files stored in memory may be greater or less than one second, as desired. For example, for sports programs of high definition (HD) programs it may be desirable to reduce the length of each file to ½ second; since as above HD programs require about 3 times the data of standard definition programs, this will still result in each file being about 50% larger than a 1 second standard definition file. In addition to MPEG-2 transport streams, the invention may be similarly applied to H.264 transport streams and other formats. Further, while it is contemplated that one use of the present invention is in embedding DVR functionality in a television set at minimal additional cost, it could also easily be adapted to set-top boxes, personal computers, or any other desired application.

The invention has been explained above with reference to several embodiments. Other embodiments will be apparent to those skilled in the art in light of this disclosure. The present invention may readily be implemented using different orders of steps, configurations other than those described in the embodiments above, or in conjunction with systems other than the embodiments described above. It should also be appreciated that the present invention can be implemented in numerous ways, including as a process, an apparatus, a system, a computer readable storage medium such as a hard disk drive, floppy disk, optical disc such as a compact disc (CD) or digital versatile disc (DVD), flash memory, etc., on which program instructions for performing the methods described herein are stored, or a computer network wherein the program instructions are sent over optical or electronic communication links. It should be noted that the order of the steps of the methods described herein may be altered within the scope of the invention. These and other variations upon the embodiments are intended to be covered by the present invention, which is limited only by the appended claims.

1. A method for storing a video signal comprising the steps of:
receiving one or more streams of broadcast video signals in a digital format, each stream containing a plurality of program signals and each program signal comprised of a series of frames;
selecting a received stream;
dividing the selected stream into groups of frames such that each group is of approximately equal broadcast time duration, without otherwise altering the format of the frames; and
storing the groups sequentially in a memory in the same order and digital format in which the stream was received.

2. The method of claim 1 wherein the digital format of the received streams of television signals is MPEG-2

3. The method of claim 1 wherein the time duration of each group is approximately one second.

4. The method of claim 1 further comprising selecting one program from the plurality of program signals, and wherein storing the groups of frames further comprises storing only the frames for the selected program.

5. The method of claim 1 wherein the memory is a flash memory.

6. The method of claim 1 wherein the memory is a hard disk.

7. A method for storing and retrieving a video signal, comprising the steps of
receiving one or more streams of broadcast video signals in a digital format, each stream containing a plurality of program signals and each program signal comprised of a series of frames;
selecting a received stream;
dividing the selected stream into groups of frames such that each group is of approximately equal broadcast time duration, without otherwise altering the format of the frames;
storing the groups sequentially in a memory in the same order and digital format in which the stream was received;
selecting a plurality of the stored groups to retrieve;
retrieving the selected stored groups; and
reproducing the broadcast video signal represented by the selected stored groups.

8. The method of claim 7 wherein the digital format of the received streams of television signals is MPEG-2

9. The method of claim 7 further comprising selecting one program from the plurality of program signals, and wherein storing the groups of frames further comprises storing only the frames for the selected program.

10. The method of claim 7 wherein the memory is a flash memory.

11. The method of claim 7 wherein the memory is a hard disk.

12. The method of claim 7 further comprising indicating a starting point from which to retrieve the plurality of stored groups of frames.

13. The method of claim 12 wherein indicating a starting point further comprises using a pointer to indicate the location in the memory of the first group of frames to be retrieved.

14. The method of claim 13 wherein the time duration of each group is approximately one second.

15. The method of claim 14 wherein the pointer is incremented after each group of frames is read to point to the next group of frames to be read.

16. The method of claim 15 wherein the pointer increments by one such that every group of frames is retrieved from the selected point at the same rate and in the same order in which the groups were received.

17. The method of claim 15 wherein the counter increments by a number n greater than one such that only 1/n of the groups of frames are retrieved, but in the same relative order in which the groups were received.

18. A system for storing and retrieving a video signal contained in a stream of broadcast video signals in a digital format, the stream containing a plurality of program signals and each program signal comprised of a series of frames, comprising:
a tuner for selecting a program from the plurality of programs contained in the stream;
a buffer for dividing the frames of the selected program into groups of frames such that each group is of approximately equal broadcast time duration, without otherwise altering the format of the frames;
memory input/output means for reading the groups of frames into and out of a memory and causing the memory to store the groups of frames sequentially in the same order and digital format in which the stream was received;
control means for designating to the input/output means which groups of frames are to be read out of the memory;
output means for providing the groups of frames to a video decoder for reproduction of the video signal represented by the selected groups of frames.

19. The system of claim 18, further comprising a memory for storing the groups of frames.

20. The system of claim 19 wherein the memory is a flash memory.

21. The system of claim 19 wherein the memory is a hard disk.

22. The system of claim 18 wherein the buffer divides the frames of the selected program into groups of frames such that the broadcast time duration of each group is approximately one second.

23. The system of claim 18 further comprising a multiplexor for selecting between providing a video decoder either the groups of frames read out of the memory or the program selected from the stream of broadcast signals.

24. The system of claim 18 wherein the control means further comprises a counter for counting the groups of frames at a chosen rate so that the control means selects groups of frames at a selected rate and may be used to provide functions including any of pause, play, play faster, play slower, fast forward, play in reverse, and rewind.
